(19) United States
(12) Patent Application Publication
(10) Pub. No.: US 2026/0060188 A1
(43) Pub. Date: Mar. 5, 2026

(54) ENERGY-AUTONOMOUS BATTERY-FREE SYSTEM FRO SMART IRRIGATION

(71) Applicant: STMicroelectronics S.r.l., Agrate Brianza (MB) (IT)

(72) Inventors: Roberto LA ROSA, Viagrande (IT); Luigi MALPIGHI, Milano (IT); Pio QUARTICELLI, Merate (LC) (IT)

(73) Assignee: STMicroelectronics S.r.l., Agrate Brianza (MB) (IT)

(21) Appl. No.: 19/380,213

(22) Filed: Nov. 5, 2025

Related U.S. Application Data
(62) Division of application No. 17/835,388, filed on Jun. 8, 2022, now Pat. No. 12,471,545.

(51) Int. Cl. A01G 25/16; H02K 7/18; H02N 2/18

(52) U.S. Cl. CPC A01G 25/167; H02K 7/1823; H02N 2/185

(57) ABSTRACT

An irrigation system includes a fluid-inlet, a first fluid-path coupled to the fluid-inlet and having a first valve for controlling fluid-flow, and a second fluid-path coupled to the fluid-inlet and having a second valve for controlling fluid-flow. Fluid flow through a power harvester coupled to the second fluid-path causes generation of electricity. An energy storage device stores the generated electricity. A sensor measures the energy stored in the energy storage device. A controller is coupled to the sensor, the first valve, and the second valve. The controller determines if the stored energy is below a threshold, to open the second valve to allow fluid-flow through the second fluid-path and activate the power harvester when the stored energy is below the threshold, to close the second valve when the stored energy reaches or exceeds the threshold, and to control the first valve independently of the electricity generation to regulate irrigation.

### RELATED APPLICATION

This application is a divisional of U.S. patent application Ser. No. 17/835,388, field Jun. 8, 2022, the contents of which are incorporated by reference in their entirety.

### TECHNICAL FIELD

This disclosure is related to the field of smart irrigation and, more particularly, to a smart irrigation system that utilizes water flow to provide electrical power for the electronics that control the valves of the system.

### BACKGROUND

Smart irrigation systems for agriculture are complex systems, extending over large areas of agricultural land. Such smart irrigation systems utilize electronic control units to provide for precisely controlled water delivery. Delivery of the electrical power utilized by such electronic control units can be a challenge.

For example, due to these large areas of land over which smart irrigation systems are utilized, as well as the fact that such agricultural land is typically remotely located, the connection of such electronic control units to the power distribution grid is impractical or impossible. In addition, the usage of rechargeable batteries that are recharged by solar panels is less than ideal because solar panels located in remote locations may be stolen, and as stated agricultural land typically is remotely located. Still further, while the usage of batteries that are hidden or buried is possible to avoid theft, such batteries are to be manually removed and recharged off site. This is rather labor intensive, leaving this approach also less than ideal.

As such, further development into the area of smart irrigation systems is needed.

### SUMMARY

A smart irrigation system is described. The system includes a fluid inlet, a first fluid path coupled to the fluid inlet and having a first valve for controlling fluid flow, and a second fluid path coupled to the fluid inlet and having a second valve for controlling fluid flow. A power harvester is coupled to the second fluid path, where fluid flow through the second fluid path causes the power harvester to generate electrical energy. The system includes an energy storage device for storing the generated electrical energy, a sensor for measuring the energy stored in the energy storage device, and a controller operatively coupled to the sensor, the first valve, and the second valve. The controller is configured to determine if the stored energy is below a threshold, to open the second valve to allow fluid flow through the second fluid path and activate the power harvester when the stored energy is below the threshold, to close the second valve when the stored energy reaches or exceeds the threshold, and to control the first valve independently of the electrical energy generation to regulate irrigation.

The controller may use a hysteresis band for the threshold to prevent rapid cycling of the second valve.

The system may include a communication interface for receiving external commands to control the first valve.

The system may include an environmental sensor, with the controller adjusting operation of the first valve based on input from the environmental sensor.

The power harvester may be a micro-hydro turbine.

The first valve and the second valve may be independently controllable.

The energy storage device may be a supercapacitor.

The controller may communicate system status and energy levels to a remote device.

The first fluid path may be connected to an irrigation output for watering plants.

The sensor may include a voltage divider circuit configured to produce a sense voltage proportional to a voltage across the energy storage device.

The controller may determine the stored energy by comparing the sense voltage to one or more reference voltages using a comparator circuit.

The controller may include an analog-to-digital converter configured to digitize the sense voltage and determine stored energy by software comparison.

The controller may use separate upper and lower threshold values to define a hysteresis band for activating and deactivating the power harvester.

The system may include a voltage converter configured to receive energy from the power harvester and provide a regulated voltage to the controller and valves.

The voltage converter may include a DC-DC converter followed by a voltage regulator.

The energy storage device may supply electrical power to both the controller and the valves during periods of no water flow.

An outlet of the power harvester may be coupled to an irrigation output so that harvested fluid contributes to irrigation flow.

The power harvester outlet may discharge to a ground drain or collection tank separate from an irrigation output.

The first and second valves may be solenoid valves driven by independent valve driver circuits.

The valve driver circuits may be powered by the energy storage device.

A method of operating a smart irrigation system is also described. The method involves fluidly coupling a first controllable valve between a system inlet and a system outlet pipe. A second controllable valve is fluidly coupled between the system inlet and a power harvester such that fluid flows from the system inlet into the power harvester when the second controllable valve is open, with the power harvester generating power when fluid flows through it. The generated power is stored, the stored power is monitored, the second controllable valve is opened when the stored power is insufficient for system operation, and the second controllable valve is closed when the stored power is sufficient for system operation so that the power harvester is inactive when adequate stored power is available.

Storing the power generated by the power harvester may include storing the power as voltage across a supercapacitor.

Monitoring the stored power may include monitoring the voltage stored across the supercapacitor.

The stored power may be considered insufficient for system operation when the voltage stored across the supercapacitor falls below a lower threshold.

The stored power may be considered sufficient for system operation when the voltage stored across the supercapacitor rises to equal a higher threshold.

The stored power may be considered insufficient for system operation when a divided version of the voltage stored across the supercapacitor falls below a lower threshold, and may be considered sufficient for system operation when the divided version of the voltage rises to equal a higher threshold.

The method may further include opening the first controllable valve based upon a command received through a communications interface.

### BRIEF DESCRIPTION OF THE DRAWINGS

FIG. 1 is a schematic block diagram of a first smart irrigation system disclosed herein.

FIG. 2 is a schematic block diagram of a second smart irrigation system disclosed herein.

FIG. 3 is a schematic block diagram of the first smart irrigation system in which first potential implementation details of the energy storage element, sensor, and comparison circuit are shown.

FIG. 4 is a schematic block diagram of the first smart irrigation system in which second potential implementation details of the energy storage element, sensor, and comparison circuit are shown.

FIG. 5 is a schematic block diagram of the first smart irrigation system in which third potential implementation details of the energy storage element, sensor, and comparison circuit are shown.

FIG. 6 is a diagrammatical block diagram of a smart lawn sprinkler system incorporating multiple instances of the first smart irrigation system of FIG. 1.

### DETAILED DESCRIPTION

The following disclosure enables a person skilled in the art to make and use the subject matter disclosed herein. The general principles described herein may be applied to embodiments and applications other than those detailed above without departing from the spirit and scope of this disclosure. This disclosure is not intended to be limited to the embodiments shown, but is to be accorded the widest scope consistent with the principles and features disclosed or suggested herein.

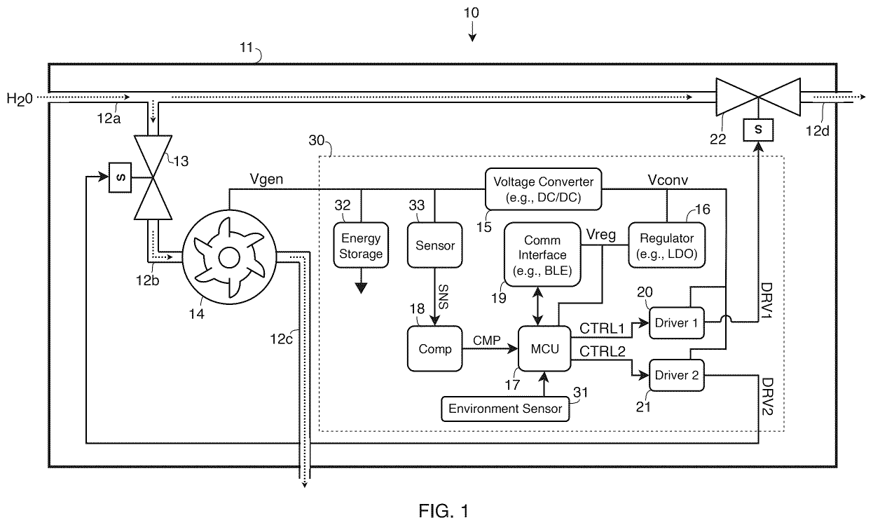

A first smart irrigation system 10 is now described with reference to FIG. 1. The smart irrigation system 10 is contained within an environmentally resistant housing 11. Fluid piping 12 includes an inlet pipe 12a through which pressurized water enters the housing 11. A first solenoid valve 22 has an inlet that is coupled in fluid communication with the inlet pipe 12a and an outlet that is coupled in fluid communication with an outlet pipe 12d through which pressurized water exits the housing 13, with the actuation of the first solenoid valve 22 being selectively controlled by a drive signal DRV1. Through proper driving of the first solenoid valve 22, the flow of water through the output pipe 12d can be controlled in a range from zero flow to maximum flow. This output pipe 12d may be connected to a water distribution device, such as a sprinkler, to achieve desired watering of the agricultural land on which the smart irrigation system 10 is installed.

A second solenoid valve 13 has an inlet that is coupled in fluid communication with the inlet pipe 12a and an outlet that is coupled in fluid communication with a harvester inlet pipe 12b, with the actuation of the second solenoid valve being controlled by a drive signal DRV2. A power harvester 14 (e.g., a water turbine that generates electrical power, or a device that utilizes piezoelectric, electromagnetic, or electrostatic approaches to exploit vibrations induced by the water flow in the pipes to generate electrical power) is fluidly connected between the harvester inlet pipe 12b and a harvester outlet pipe 12c. In this embodiment, the harvester outlet pipe 12c exits the housing 11 and may be arranged to simply drain onto or into the ground, or into a collection tank. Through proper driving of the second solenoid valve 13, the amount of fluid flow through the power harvester 14 can be controlled in a range from zero flow to maximum flow.

Although the valves 22 and 13 are described above and below as being solenoid valves, the valves may be of any type.

Flow of pressured water from the inlet 12a, through the solenoid valve 13, through the harvester inlet pipe 12b, through the power harvester 14 itself, and out through the harvester outlet pipe 12c results in generation of electrical power by the power harvester 14, such as DC electrical power. The current output by the power harvester 14 during power generation is used to charge an energy storage element 32 connected between the power output terminal of the power harvester 14 and ground, with a generated voltage Vgen therefore being generated across the energy storage element 32.

A sensor 33 is connected between the power output terminal of the power harvester 14 and ground, with a sense signal SNS being generated by the sensor 33. A comparison circuit 18 receives the sense signal SNS as input and outputs a comparison output CMP at its output indicating whether the sense signal SNS is above or below a threshold value.

A voltage converter 15 (e.g., a DC/DC voltage converter, such as a low dropout regulator) receives the generated voltage Vgen and provides a converted voltage Vconv to a voltage regulator 16 (e.g., a low dropout regulator), as well as to valve drivers 20 and 21. The voltage regulator 16 outputs a regulated voltage Vreg to power a communication interface 19 (e.g., Bluetooth low energy transceiver) and a microcontroller 17. The communication interface 19 is in bidirectional communication with the microcontroller 17, and the microcontroller receives the comparison output CMP, as well as the output of an optional environment sensor 31 or sensors (e.g., moisture sensor), as input, and respectively provides output control signals CTRL1 and CTRL2 to the valve drivers 20 and 21.

In particular, the output control signal CTRL1 is provided by the microcontroller 17 based upon internal programming, based upon data from the environment sensor 31, or based upon data received via the communications interface 19. The driver 20 generates the drive signal DRV1 for the first solenoid valve 22 from the control signal CTRL1. Since the first solenoid valve 22 is used to regulate flow of water to a water distribution device, the control signal CTRL1 therefore controls the flow of water to the water distribution device.

The output control signal CTRL2 is provided by the microcontroller 17 based upon the comparison output CMP to thereby control the flow of water through the solenoid valve 13 and in turn the power harvester 14—thus, the output control signal CTRL2 controls the generation of power by the power harvester 14. Since the power harvester 14 may have moving parts (e.g., consider the case of a water turbine) and since moving parts wear out over time, out of a desire to extend maintenance intervals of the smart irrigation system 10 to be as long as possible, it is desired for the power harvester 14 to be moving/operating as infrequently as possible. Therefore, the microcontroller 17 uses the sensor 33 to monitor the status of the voltage Vgen across the energy storage device 32, and uses the comparison circuit 18 to determine when the voltage Vgen across the energy storage device falls below and rises above a threshold or thresholds. When the microcontroller 17 has determined that the voltage Vgen across the energy storage device 32 has fallen below the threshold or thresholds (e.g., falls below a first threshold), the microcontroller 17 generates the control signal CTRL2 so as to cause the driver 21 to generate the drive signal DRV2 in such a fashion to control the solenoid valve 13 to permit flow of water through the harvester 14 to thereby generate power which is used to recharge the energy storage device 32. When the voltage Vgen across the energy storage device 32 rises above the threshold or thresholds (e.g., rises above a second threshold that is a higher value than the first threshold) as a result of the recharging provided by power generation by the harvester 14, the microcontroller 17 generates the control signal CTRL2 so as to cause the driver 21 to generate the drive signal DRV2 in such a fashion to close the solenoid valve 13 to cease the flow of water through the harvester 14, thereby stopping operation of the harvester 14 once the energy storage device 32 is sufficiently charged. This reduces the operation time of the harvester 14 to a minimum, thereby increasing the useful life of the harvester 14 and increasing the maintenance intervals of the smart irrigation system 10 since the solenoid valve 13 opens to permit water to flow through the harvester 14 when charging of the energy storage device 32 is desired, and water is otherwise not permitted to flow through the harvester 14.

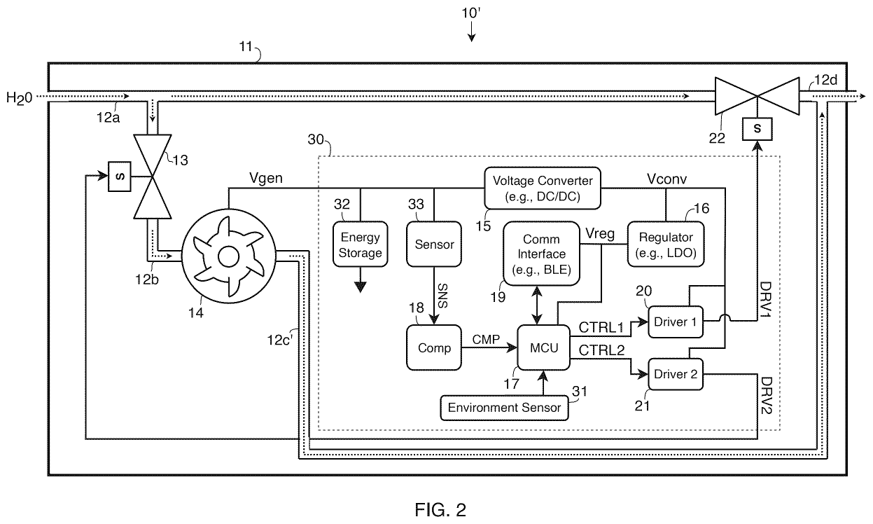

In another configuration, the harvester output pipe 12c′ may be connected to the outlet pipe 12d as shown in FIG. 2.

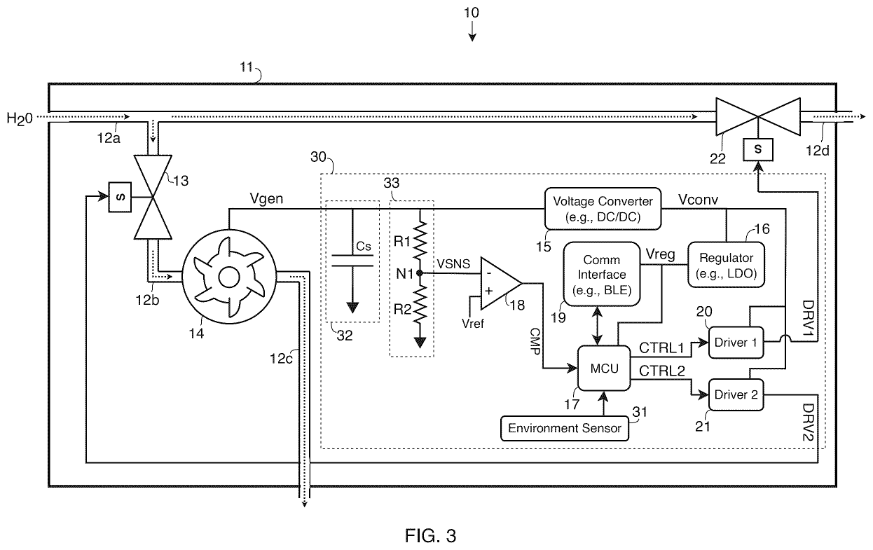

Another possible implementation option is now described with reference to FIG. 3. The energy storage device 32 may be a supercapacitor Cs. In addition, the sensor 33 may be a resistive divider formed by series-connected resistors R1 and R2 is connected between the power output terminal of the power harvester 14 and ground, with a sense voltage VSNS being generated at the tap N1 between resistor R1 and R2. The comparison circuit 18 may be a comparator having an inverting input terminal connected to receive the sense voltage VSNS, a non-inverting input terminal connected to receive a reference voltage Vref1, and an output at which the comparison output CMP is generated and passed to the microcontroller 17. Here, when VSNS falls below the reference voltage Vref1, the comparison circuit 18 asserts the comparison output CMP, and when VSNS rises above the reference voltage Vref1, the comparison circuit 18 deasserts the comparison output CMP.

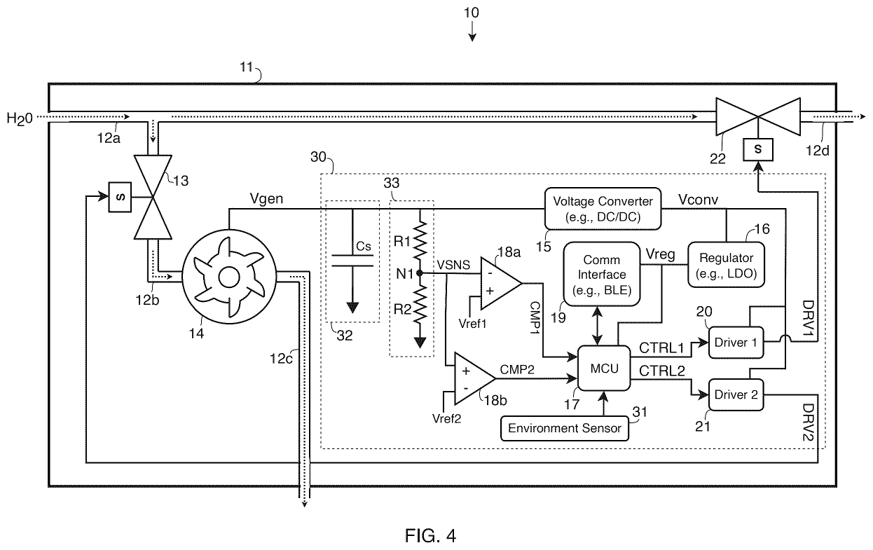

Yet another possible implementation option is now described with reference to FIG. 4. The energy storage device 32 may be a supercapacitor Cs. In addition, the sensor 33 may be a resistive divider formed by series-connected resistors R1 and R2 is connected between the power output terminal of the power harvester 14 and ground, with a sense voltage VSNS being generated at the tap N1 between resistor R1 and R2. The comparison circuit includes a first comparator 18a having a non-inverting input terminal connected to receive the sense voltage VSNS, an inverting input terminal connected to receive a reference voltage Vref2 (which is higher than the Vref1), and an output at which the comparison output CMP2 is generated and passed to the microcontroller 17. Here, when VSNS rises above the reference voltage Vref2, the comparison circuit 18a asserts the comparison output CMP2.

The comparison circuit includes a second comparator 18b having a non-inverting input terminal connected to receive the sense voltage VSNS, an inverting input terminal connected to receive a reference voltage Vref2, and an output at which the comparison output CMP2 is generated and passed to the microcontroller 17. Here, when VSNS falls below the reference voltage Vref1, the comparison circuit 18a asserts the comparison output CMP1.

As stated, the reference voltage Vref1 is lower than the reference voltage Vref2. Therefore, the microcontroller 17 initiates power generation when the comparison output CMP1 is asserted—power generation is initiated when the voltage Vgen has fallen below a lower threshold. The microcontroller 17 then ceases power generation when the comparison output CMP2 is asserted—power generation is ceased when the voltage Vgen has increased to match or exceed a higher threshold.

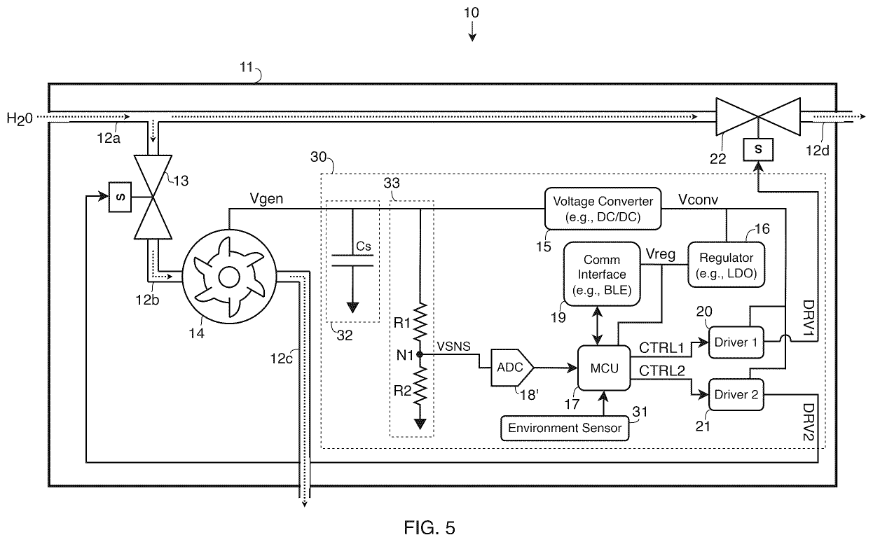

Instead of using comparators, an analog to digital converter (ADC) 18′ may be used to digitize VSNS, as shown in FIG. 5. In this case, the microcontroller 17 receives the digitized version of VSNS from the ADC 18′, performs the above-described comparisons to a stored threshold value or stored threshold values, and based upon the comparisons, initiates and causes power generation accordingly as described above.

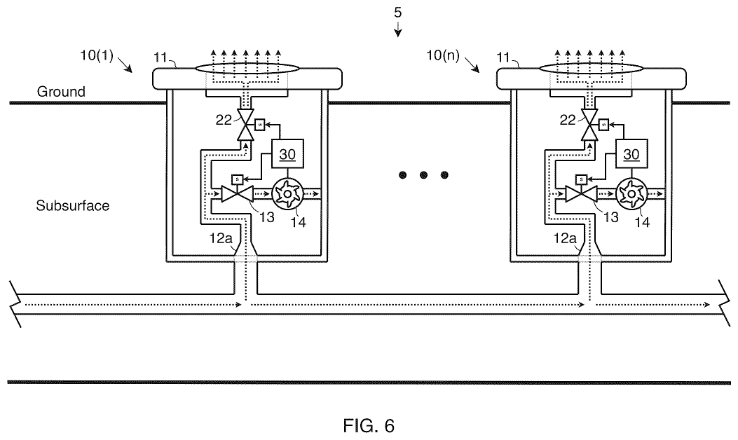

The housing 11 of the smart irrigation system 10 may be small and sized so as to fit in a typical hole formed in the ground to contain a sprinkler, and the other components of the smart irrigation system 10 may be accordingly sized to fit within the housing when it is so sized. Therefore, multiple instances of the smart irrigation system, shown in FIG. 6 as smart irrigation systems 10(1), . . . , 10(n) may be installed within a single field and receive water from a same water pipe. Here, the environment sensor 31 may be a moisture sensor. This permits the formation of a smart sprinkler system 5, shown in FIG. 6, which waters the parts of the field (e.g., a lawn) that are dry (since each smart irrigation system 10(1) . . . , 10(n) turns on or off based on its moisture sensor), thereby saving a large amount of water by avoiding watering areas of the field that are sufficiently moist.

Modifications and variations may be made to what has been described and illustrated herein, without thereby departing from the scope of this disclosure, as defined in the annexed claims.

While the disclosure has been described with respect to a limited number of embodiments, those skilled in the art, having benefit of this disclosure, will appreciate that other embodiments can be envisioned that do not depart from the scope of the disclosure as disclosed herein. Accordingly, the scope of the disclosure shall be limited only by the attached claims.

1. A smart irrigation system comprising:
a fluid inlet;
a first fluid path coupled to the fluid inlet and having a first valve for controlling fluid flow;
a second fluid path coupled to the fluid inlet and having a second valve for controlling fluid flow;
a power harvester coupled to the second fluid path, wherein fluid flow through the second fluid path causes the power harvester to generate electrical energy;
an energy storage device for storing the generated electrical energy;
a sensor for measuring the energy stored in the energy storage device; and
a controller operatively coupled to the sensor, the first valve, and the second valve;
wherein the controller is configured to:
determine if the stored energy is below a threshold;
open the second valve to allow fluid flow through the second fluid path and activate the power harvester when the stored energy is below the threshold;
close the second valve when the stored energy reaches or exceeds the threshold; and
control the first valve independently of the electrical energy generation to regulate irrigation.

2. The smart irrigation system of claim 1, wherein the controller uses a hysteresis band for the threshold to prevent rapid cycling of the second valve.

3. The smart irrigation system of claim 1, further comprising a communication interface for receiving external commands to control the first valve.

4. The smart irrigation system of claim 1, further comprising an environmental sensor, wherein the controller adjusts operation of the first valve based on input from the environmental sensor.

5. The smart irrigation system of claim 1, wherein the power harvester is a micro-hydro turbine.

6. The smart irrigation system of claim 1, wherein the first valve and the second valve are independently controllable.

7. The smart irrigation system of claim 1, wherein the energy storage device is a supercapacitor.

8. The smart irrigation system of claim 1, wherein the controller communicates system status and energy levels to a remote device.

9. The smart irrigation system of claim 1, wherein the first fluid path is connected to an irrigation output for watering plants.

10. The smart irrigation system of claim 1, wherein the sensor comprises a voltage divider circuit configured to produce a sense voltage proportional to a voltage across the energy storage device.

11. The smart irrigation system of claim 10, wherein the controller determines the stored energy by comparing the sense voltage to one or more reference voltages using a comparator circuit.

12. The smart irrigation system of claim 10, wherein the controller comprises an analog-to-digital converter configured to digitize the sense voltage and determine stored energy by software comparison.

13. The smart irrigation system of claim 1, wherein the controller uses separate upper and lower threshold values to define a hysteresis band for activating and deactivating the power harvester.

14. The smart irrigation system of claim 1, further comprising a voltage converter configured to receive energy from the power harvester and provide a regulated voltage to the controller and valves.

15. The smart irrigation system of claim 14, wherein the voltage converter comprises a DC-DC converter followed by a voltage regulator.

16. The smart irrigation system of claim 1, wherein the energy storage device supplies electrical power to both the controller and the valves during periods of no water flow.

17. The smart irrigation system of claim 1, wherein an outlet of the power harvester is coupled to an irrigation output so that harvested fluid contributes to irrigation flow.

18. The smart irrigation system of claim 1, wherein the power harvester outlet discharges to a ground drain or collection tank separate from an irrigation output.

19. The smart irrigation system of claim 1, wherein the first and second valves are solenoid valves driven by independent valve driver circuits.

20. The smart irrigation system of claim 19, wherein the valve driver circuits are powered by the energy storage device.

21. A method of operating a smart irrigation system including a first controllable valve coupled in fluid communication between a system inlet and a system outlet pipe, the method comprising:
fluidly coupling a second controllable valve between the system inlet and a power harvester such that fluid flows from the system inlet into the power harvester when the second controllable valve is open, with the power harvester generating power when fluid flows therethrough;
storing the power generated by the power harvester;
monitoring the stored power;
opening the second controllable valve when the stored power is insufficient for system operation; and
closing the second controllable valve when the stored power is sufficient for system operation such that the power harvester is not in operation when the stored power is sufficient for system operation.

22. The method of claim 21, wherein storing the power generated by the power harvester comprises storing power generated by the power harvester as voltage across a supercapacitor.

23. The method of claim 22, wherein monitoring the stored power comprises monitoring the voltage stored across the supercapacitor.

24. The method of claim 23, wherein the stored power is insufficient for system operation when the voltage stored across the supercapacitor falls below a lower threshold.

25. The method of claim 23, wherein the stored power is sufficient for system operation when the voltage stored across the supercapacitor rises to become equal to a higher threshold.

26. The method of claim 23, wherein the stored power is insufficient for system operation when a divided version of the voltage stored across the supercapacitor falls below a lower threshold, and wherein the stored power is sufficient for system operation when the divided version of the voltage stored across the supercapacitor rises to become equal to a higher threshold.

27. The method of claim 21, further comprising opening the first controllable valve based upon a command received via a communications interface.
